(19) United States
(12) Patent Application Publication
(10) Pub. No.: US 2002/0021806 A1
(43) Pub. Date: Feb. 21, 2002

(54) Content reproduction apparatus

(76) Inventors: Hitoshi Nara, Chiba (JP); Takehiko Tanaka, Tokyo (JP)

Correspondence Address: Jay H. Maioli, Cooper & Dunham LLP, 1185 Avenue of the Americas, New York, NY, 10036, US

(21) Appl. No.: 09/925,186

(22) Filed: Aug. 9, 2001

(30) Foreign Application Priority Data
Aug. 17, 2000 (JP) P2000-247168

(51) Int. Cl. H04N 7/167

(52) U.S. Cl. 380/201; 705/57

(57) ABSTRACT

A content reproduction apparatus uses a storage device to store a large amount of content data in encrypted fashion as well as a corresponding encryption key. When a medium is inserted and is capable of proving that a copyright fee is paid for given content data, the storage device may store this content data in unreproducible fashion. In this case, the encryption key stored in the storage device is used to decrypt the content data. When payment of the copyright fee is not proved, the content data is assumed to be unreproducible.

### BACKGROUND OF THE INVENTION

1. Field of the Invention

The present invention relates to a content reproduction apparatus which stores and reproduces a large amount of content data. More specifically, the present invention concerns a content reproduction apparatus which can solve a problem of copyright fees, provide content data inexpensively, and enable a fast install of content data.

2. Prior Art

A music reproduction apparatus called a music bank increasingly gains widespread use. Such an apparatus stores many music sources in a large-capacity storage device such as a hard disc and selects and reproduces a user-specified music source therefrom.

An ordinary computer is sold with an internal hard disc already loaded with application software. Upon purchase of the computer, the application software can be used.

However, the music source is accompanied by a problem of copyright fees. If a product is sold with many music sources stored in a large-capacity storage device such as a hard disc, such product is to be very expensive.

Conventionally, the product is sold without music sources stored in the hard disc. A music reproduction apparatus called a music bank is constructed in such a manner that a user purchases a compact disc (CD) which stores music sources therein and installs a music source on the hard disc.

According to the prior art, however, music sources need to be installed one by one on the hard disc, causing a problem of necessitating a large amount of time for installing music sources.

Recently, a way of selling music sources using the Internet is growing popular. If this sales system is used for purchasing music sources, there also arises a problem of increasing telephone charges.

### BRIEF SUMMARY OF THE INVENTION

The present invention has been made in consideration of the foregoing problems. It is therefore an object of the present invention to provide a new content reproduction apparatus which can solve a problem of copyright fees, provide content data such as music sources inexpensively, and enable a fast install of content data.

(1) In order to achieve this object, a content reproduction apparatus according to the present invention is so configured that it comprises a large-capacity storage device such as a hard disc in which a large amount of content data such as many music sources to be reproduced is stored in encrypted form not to be produced and to an encryption key for deciphering the encrypted content data is also stored.

Since the content reproduction apparatus is configured to use the storage device for storing a large amount of content data in unreproducible form, it becomes possible to sell a storage device storing a large amount of content data inexpensively.

{1}. In this configuration, the content reproduction apparatus comprises judging means for, when a medium which is capable of proving that a copyright fee is paid for given content data is inserted, judging whether the content data is stored in the storage device in unreproducible form; and execution means for making the content data specified by the judging means to be stored in unreproducible form reproducible by using an encryption key stored in the storage device.

{2}. In this configuration, the content reproduction apparatus comprises acquisition means for acquiring an identifier of content data requested for reproduction via a communication line; charging means for charging needed to acquire the identifier; judging means for judging whether the storage device stores content data indicated by the identifier acquired by the acquisition means in unreproducible form; and execution means for making the content data stored in unreproducible form reproducible by using an encryption key stored in the storage device.

In the content reproduction apparatus having configurations (1) and {1} according to the present invention, when a medium which is capable of proving that a copyright fee is paid for given content data is inserted, the judging means judges whether the content data is stored in the storage device in unreproducible form. Based on this result of judging, the execution means makes the content data specified by the judging means to be stored in unreproducible form reproducible by using a corresponding encryption key stored in the storage device.

A user purchases a medium capable of proving that a copyright fee is paid for given content data. This medium can be a CD or a medium storing content data identifiers. By inserting the medium into the content reproduction apparatus according to the present invention, the content data can be reproduced without actually installing it.

In the content reproduction apparatus having configurations (1) and {2} according to the present invention, when a communication line is used to acquire an identifier of content data requested for reproduction on condition of charging, the judging means judges whether the content data indicated by the identifier is stored in the storage device in unreproducible form. Based on this result of judging, the execution means makes the content data specified by the judging means to be stored in unreproducible reproducible form by using a corresponding encryption key stored in the storage device.

By purchasing an identifier of given content data via a communication line, the user can reproduce the content data without actually installing it.

(2) In order to achieve this object, a content reproduction apparatus according to the present invention is so configured that it uses a large-capacity storage device such as a hard disc to store a large amount of content data such as many music sources to be reproduced in encrypted form for making content data unreproducible.

Since the content reproduction apparatus is configured to use the storage device for storing a large amount of content data in unreproducible form, it becomes possible to sell a storage device storing a large amount of content data inexpensively.

{3}. In this configuration, the content reproduction apparatus comprises judging means for, when a medium which stores an encryption key needed to decrypt given content data therein is inserted, judging whether the content data is stored in the storage device in unreproducible form; and execution means for making the content data specified by the judging means to be stored in unreproducible form reproducible by using an encryption key recorded in the inserted medium.

{4}. In this configuration, the content reproduction apparatus comprises acquisition means for acquiring an encryption key needed to decrypt given content data; charging means for charging needed to acquire the encryption key; judging means for judging whether the storage device stores content data corresponding to the encryption key acquired by the acquisition means in unreproducible form; and execution means for making the content data stored in unreproducible form reproducible by using an encryption key acquired by the acquisition means.

In the content reproduction apparatus having configurations (2) and {3} according to the present invention, when a medium is inserted and stores an encryption key needed to decrypt given content data, the judging means judges whether the content data is stored in the storage device in unreproducible form. Based on this judging result, the execution means makes the content data specified by the judging means to be stored in unreproducible form reproducible by using an encryption key stored in the inserted medium.

A user purchases a medium recording an encryption key needed to decrypt given content data. By inserting the medium into the content reproduction apparatus according to the present invention, the content data can be reproduced without actually installing it.

In the content reproduction apparatus having configurations (2) and {4} according to the present invention, when a communication line is used to acquire an encryption key needed to decrypt given content data on condition of charging, the judging means judges whether the content data is stored in the storage device in unreproducible form. Based on this result of judging, the execution means makes the content data specified by the judging means to be stored in unreproducible form reproducible by using the acquired encryption key.

By purchasing an encryption key needed to decrypt given content data via a communication line, the user can reproduce the content data without actually installing it.

As mentioned above, the content reproduction apparatus according to the present invention can solve a problem of copyright fees, provide content data such as music sources inexpensively, and fast install content data.

According to the present invention as mentioned above, the user can store a large amount of content data in a storage device and reproduce it by means of simple verification processing. It is possible to save time for recording a large amount of content data, storing a large amount of content data in a storage device, and reproducing it.

A corporation can provide storage devices for storing a large amount of content data at low costs by solving copyright problems. Further, it is possible to make an initial profit and ensure continued profits by selling information for decrypting content data.

### BRIEF DESCRIPTION OF THE DRAWINGS

FIG. 1 shows an exemplary embodiment of a music reproduction apparatus according to the present invention;

FIG. 2 shows an exemplary embodiment of a processing flow executed by a control section;

FIG. 3 shows an exemplary embodiment of a processing flow executed by a control section;

FIG. 4 shows an exemplary embodiment of a processing flow executed by a control section;

FIG. 5 shows an exemplary embodiment of a data structure in a hard disc;

FIG. 6 is a diagram for explaining the processing executed by the control section;

FIG. 7 shows another embodiment of a processing flow executed by a control section;

FIG. 8 shows another embodiment of a processing flow executed by a control section;

FIG. 9 is shows an exemplary embodiment of a data structure in a hard disc; and

FIG. 10 is a diagram for explaining the processing executed by the control section.

### DESCRIPTION OF THE PREFERRED EMBODIMENTS

Embodiments of the present invention will be described in further detail with reference to the accompanying drawings.

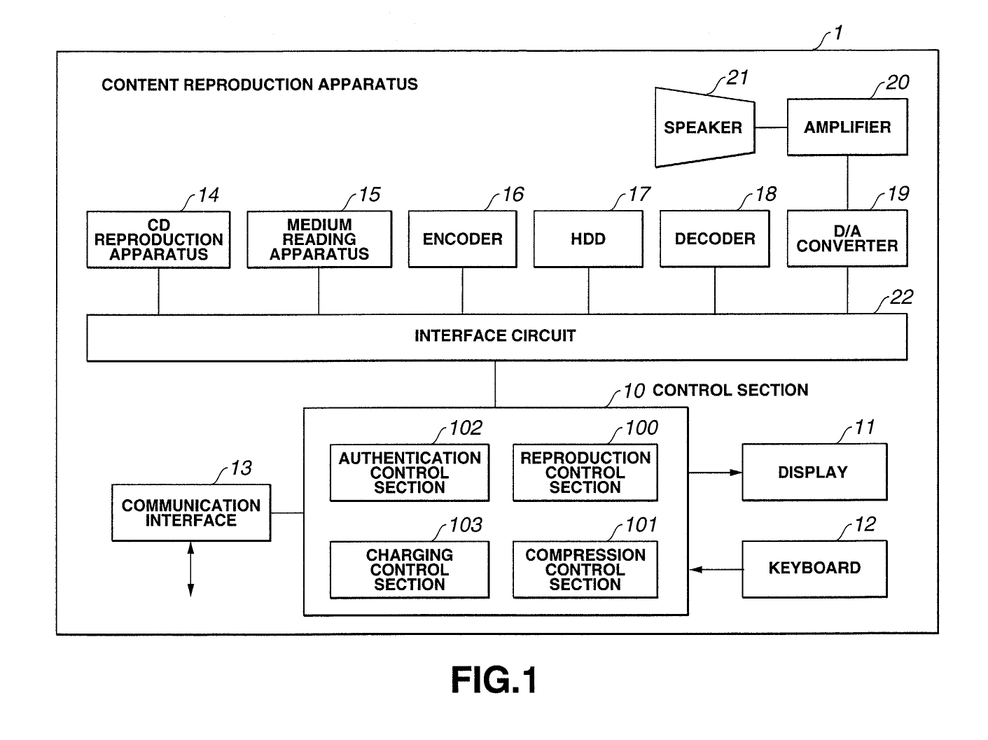

FIG. 1 shows an embodiment of a music reproduction apparatus 1 according to the present invention.

As shown in this figure, the music reproduction apparatus 1 according to the present invention is based on a program running on a CPU. The music reproduction apparatus 1 comprises a control section 10, a display 11, a keyboard 12, a communication I/F 13, a CD reproduction apparatus 14, a medium read apparatus 15, an encoder 16, a hard disc 17, a decoder 18, a D/A converter 19, an amplifier 20, a speaker 21, and an interface circuit 22. The control section 10 executes processing for implementing the present invention. The communication I/F 13 manages communication interface processing with a music distribution server (not shown). The CD reproduction apparatus 14 reads a music source recorded on a CD. The medium read apparatus 15 reads data from a portable small-scale storage medium such as a memory card. The encoder 16 encodes a music source read by the CD reproduction apparatus 14. The hard disc 17 has a data structure characteristic of the present invention. The decoder 18 decodes the music source encoded by the encoder 16. The D/A converter 19 converts the music source decoded by the decoder 18 from a digital signal to an analog signal. The amplifier 20 amplifies the music source converted by the D/A converter 19. The speaker 21 outputs the music source amplified by the amplifier 20. The interface circuit 22 manages interface processing among these constituent components.

The control section 10 comprises a reproduction control section 100, a compression control section 101, an authentication control section 102, and a charging control section 103. The reproduction control section 100 controls music source reproduction. The compression control section 101 controls music source compression. The authentication control section 102 controls music source authentication. The charging control section 103 controls charging for a music source.

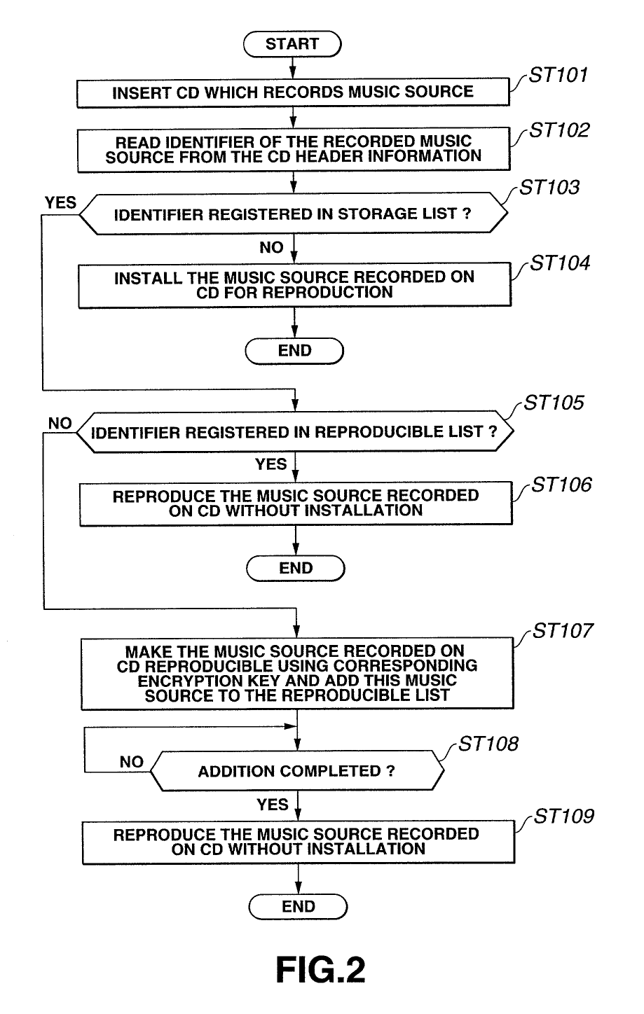

FIGS. 2 to 4 show embodiments of processing flows performed by the control section 10. Described below is an embodiment of the present invention according to the processing flow.

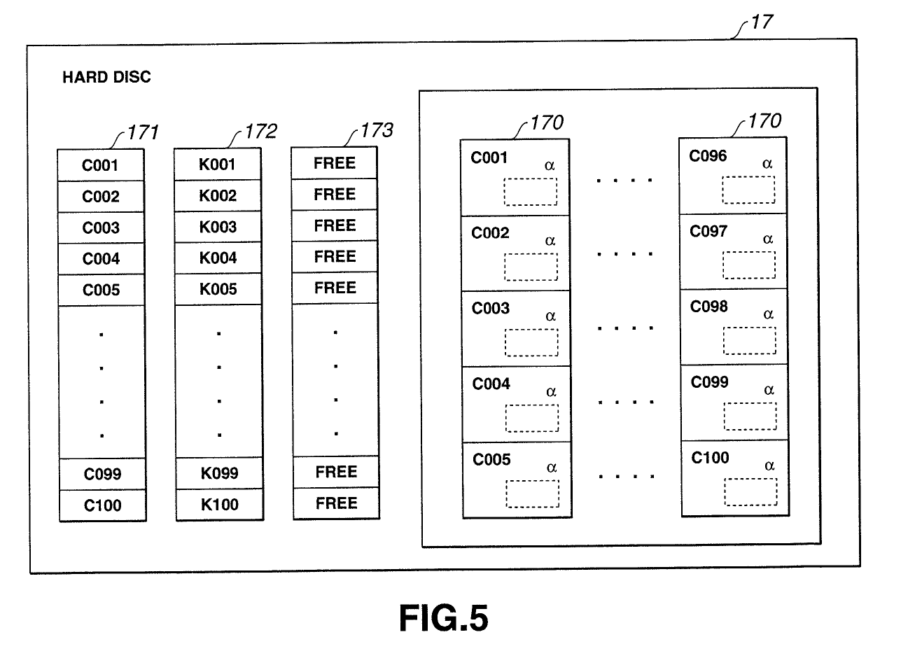

FIG. 5 shows an embodiment of a data structure in a hard disc 17 prepared for implementing an embodiment of the present invention.

As shown in FIG. 5, the hard disc 17 stores a plurality of encrypted music sources 170. The hard disc contains a storage list 171, an encryption key list 172, and a reproducible list 173. The storage list 171 manages identifiers of the stored music sources 170. The encryption key list 172 manages encryption keys for decrypting stored music sources 170. The reproducible list 173 manages identifiers of the music sources 170 which are decrypted to be reproducible.

In FIG. 5, the hard disc 17 is assumed to store 100 music sources 170, namely C001 to C100. Also, it is assumed to use 100 encryption keys K001 to K100 for decrypting these music sources 170.

FIG. 5 shows α which is a data area for the encryption key assigned to the music source 170. When the corresponding encryption key is embedded in this area, that music source 170 becomes reproducible.

According to this embodiment, a music source shop sells the hard disc 17 storing a plurality of encrypted music sources 170 without embedding encryption keys in any of these music sources 170. Even if a user purchases the hard disc 17 from the shop, the user cannot reproduce the music source stored therein. Consequently, the music source shop can sell the hard disc 17 inexpensively.

The user may purchase a CD storing a music source from the shop, insert the CD, and issue a request to reproduce the music source. In this case, the control section 10 performs the music source reproduction according to a processing flow in FIG. 2 when the hard disc 17 is mounted.

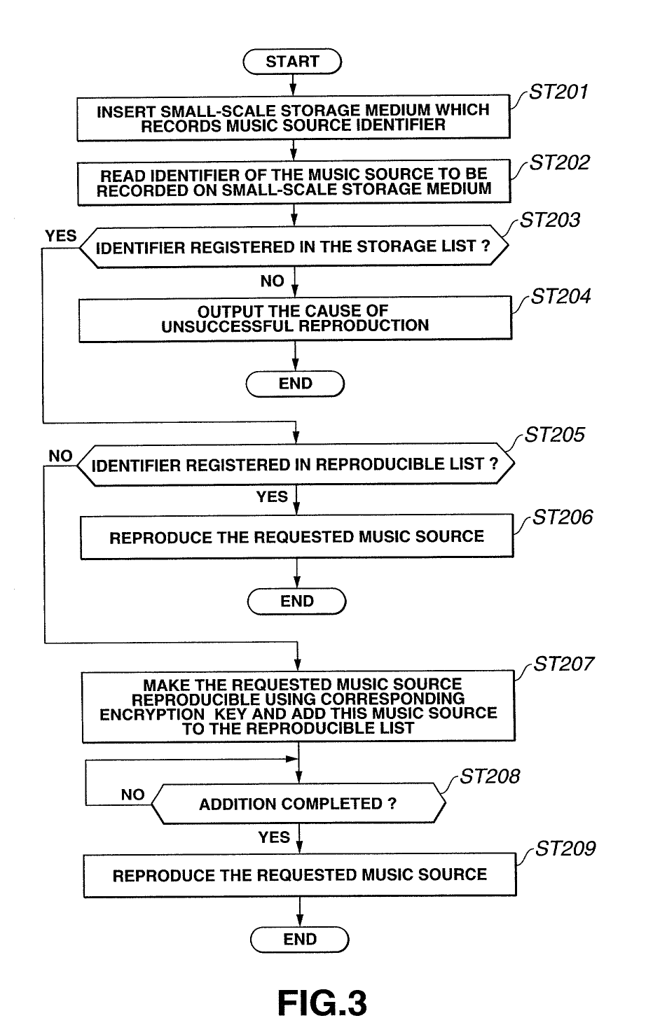

The user may purchase a small-scale storage medium such as a memory card storing a music source identifier from the shop, insert the small-scale storage medium, and issue a request to reproduce the music source. In this case, the control section 10 performs the music source reproduction according to a processing flow in FIG. 3 when the hard disc 17 is mounted.

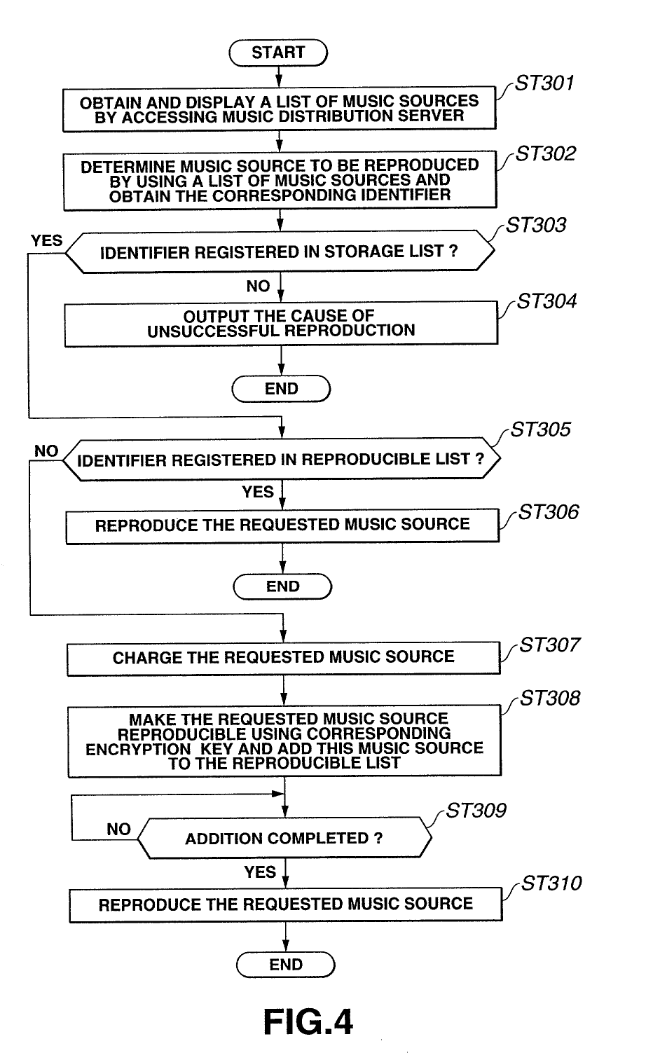

The user may acquire an identifier of a music source to be requested from a music distribution server and issue a request to reproduce the music source. In this case, the control section 10 performs the music source reproduction according to a processing flow in FIG. 4 when the hard disc 17 is mounted.

First, the following describes the music source reproduction performed by the control section 10 according to the processing flow in FIG. 2.

When the user inserts the CD for recording music sources and issues a request to reproduce the music source, the control section 10 first loads the CD into the CD reproduction apparatus 14 at step ST101 as shown in the processing flow of FIG. 2.

At step ST102, header information is read from the inserted CD to read an identifier of a music source recorded on the inserted CD. In addition to this identifier, the header information contains a recording location of the recorded music source.

At step ST103, it is judged whether the read identifier is registered in the storage list 171 stored in the hard disc 17. When it is judged that the corresponding identifier is not registered, control proceeds to step ST104 to install and reproduce the music source recorded on the CD.

The CD may contain a music source which is not stored in the hard disc 17 purchased from the shop. In this case, same processing as for an ordinary music reproduction apparatus is performed. Namely, the encoder 16 is used to encode a music source read by the CD reproduction apparatus 14. The encoded music source is temporarily stored in the hard disc 17. Then the decoder 18 is used to decode the encoded music source. The decoded music source is output to the speaker 21 for reproduction via the D/A converter 19 and the amplifier 20.

When the identifier of the music source read from the CD is judged to be registered in the storage list 171 of the hard disc 17 at step ST103, control proceeds to step ST105. It is judged whether that identifier is registered in the reproducible list 173 of the hard disc 17.

When it is judged that the reproducible list 173 does not register the identifier of the music source read from the CD, control proceeds to step ST107. The encryption key list 172 registers an encryption key used for decrypting the music source 170 indicated by the identifier. This encryption key is used to make the music source (also recorded on the CD) indicated by the identifier reproducible. This music source is added to the reproducible list 173.

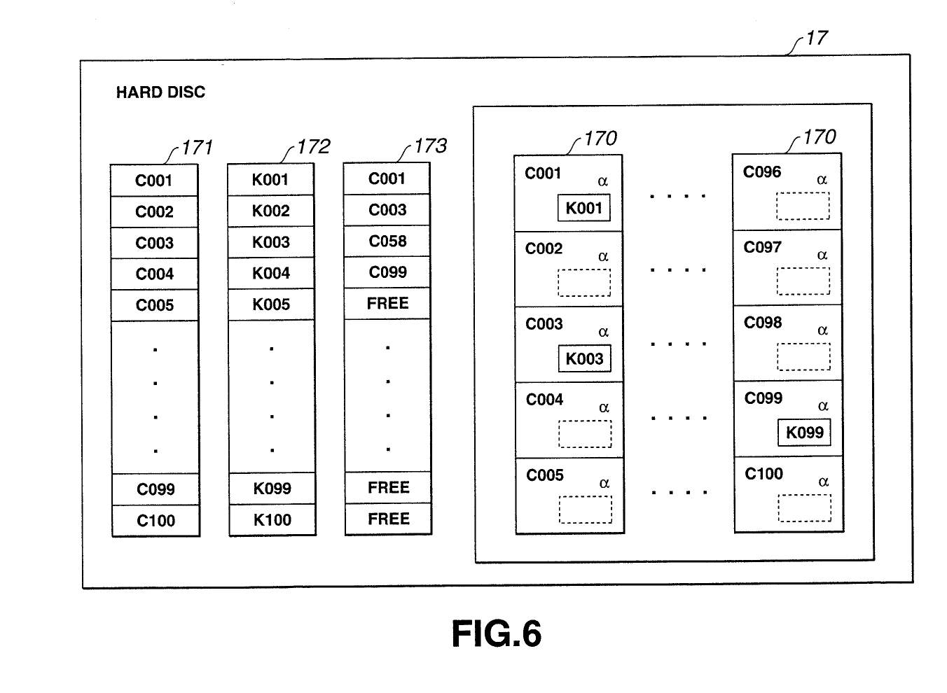

As shown in FIG. 6, for example, the music source read from the CD is assigned with identifier C099. In this case, encryption key K099 is embedded in the data area α for the music source 170 corresponding to C099. As a result, this music source 170 becomes reproducible and is added to the reproducible list 173.

Then, at step ST108, the control section waits for completion of adding the music source to the reproducible list 173. When confirming completion of this step, the control section proceeds to step ST109 to reproduce the music source 170 added to the reproducible list 173 by using the decoder 18. This reproduces the music source and terminates the processing without installing the music source recorded on the inserted CD.

When it is judged at step ST105 that an identifier of the music source read from the CD is registered in the reproducible list 173, control proceeds to step ST106. The decoder 18 is used to reproduce the music source 170 indicated by the identifier stored in the hard disc 17. This reproduces the music source and terminates the processing without installing the music source recorded on the inserted CD.

When the music source read from the CD is stored in the hard disc 17 and is also registered in the reproducible list 173 due to a previous reproduction request, the music source is already placed in a reproducible state. The music source is immediately reproduced without processing steps ST107 to ST109.

As mentioned above, when the user inserts a CD for recording a music source and issues a request to reproduce the music source, the music source may be already stored in the hard disc 17. In this case, the control section 10 immediately reproduces that music source without reading the music source from the CD.

Accordingly, the user purchases a CD storing music sources to pay a royalty of the copyright. When the CD is inserted into the music reproduction apparatus 1 according to the present invention, the music source may be stored in the hard disc 17. In this case, the user can immediately reproduce the music source without actually installing it.

Next, the following describes the music source reproduction performed by the control section 10 according to the processing flow in FIG. 3.

The user may purchase a small-scale storage medium such as a memory card storing a music source identifier from the shop, insert the small-scale storage medium, and issue a request to reproduce the music source. In this case, the control section 10 first inserts the small-scale storage medium into the medium read apparatus 15 at step ST201 as shown in the processing flow of FIG. 3.

At step ST202, the control section reads an identifier of a music source recorded on the inserted small-scale storage medium. At step ST203, it is judged whether the read identifier is registered in the storage list 171 stored in the hard disc 17. When it is judged that the corresponding identifier is not registered, control proceeds to step ST204. The control section outputs information indicating unsuccessful reproduction and terminates the processing.

When the identifier of the music source read from the small-scale storage medium is judged to be registered in the storage list 171 of the hard disc 17 at step ST203, control proceeds to step ST205. It is judged whether the identifier is registered in the reproducible list 173 of the hard disc 17.

When it is judged that the reproducible list 173 does not register the identifier of the music source read from the small-scale storage medium, control proceeds to step ST207. The encryption key list 172 registers an encryption key used for decrypting the music source 170 indicated by the identifier. This encryption key is used to make the music source indicated by the identifier reproducible. This music source 170 is added to the reproducible list 173.

As shown in FIG. 6, for example, the music source read from the small-scale storage medium is assigned with identifier C099. In this case, encryption key K099 is embedded in the data area a for the music source 170 corresponding to C099. As a result, this music source 170 becomes reproducible and is added to the reproducible list 173.

Then, at step ST208, the control section waits for completion of adding the music source to the reproducible list 173. When confirming completion of this step, the control section proceeds to step ST209 to reproduce the music source 170 added to the reproducible list 173 by using the decoder 18. This reproduces the music source and terminates the processing without installing the music source indicated by the identifier read from the inserted small-scale storage medium.

When it is judged at step ST205 that an identifier of the music source read from the small-scale storage medium is registered in the reproducible list 173, control proceeds to step ST206. The decoder 18 is used to reproduce the music source 170 indicated by the identifier stored in the hard disc 17. This reproduces the music source and terminates the processing without installing the music source indicated by the identifier read from the inserted small-scale storage medium.

As mentioned above, when the user inserts a small-scale storage medium for recording a music source identifier and issues a request to reproduce the music source, the music source may be already stored in the hard disc 17. In this case, the control section 10 reproduces the music source.

Accordingly, the user pays a royalty of the copyright to allow the small-scale storage medium to record an identifier of the music source 170 recorded on the hard disc 17. By inserting the small-scale storage medium into the music reproduction apparatus 1 according to the present invention, the user can immediately reproduce the music source 170 without actually installing it.

Next, the following describes the music source reproduction performed by the control section 10 according to the processing flow in FIG. 4.

The user may acquire an identifier of a music source from a music distribution server and issue a request to reproduce the music source. In this case, the control section 10 first accesses the music distribution server at step ST301 as shown in the processing flow of FIG. 4. By doing so, the control section acquires a list of music sources to be reproduced and displays it on the display 11.

At step ST302, the displayed list of music sources is used for interaction between the user and the music distribution server to judge a music source to be reproduced and acquire the corresponding identifier. At step ST303, it is judged whether the acquired identifier is registered in the storage list 171 of the hard disc 17. When it is judged that the identifier is not registered in the list, control proceeds to step ST304. The control section outputs information indicating unsuccessful reproduction and terminates the processing.

When the identifier of the music source acquired from the music distribution server is judged to be registered in the storage list 171 of the hard disc 17 at step ST303, control proceeds to step ST305. It is judged whether that identifier is registered in the reproducible list 173 of the hard disc 17.

When it is judged that the reproducible list 173 does not register the identifier of the music source acquired from the music distribution server, control proceeds to step ST307. The control section charges the music source requested for reproduction by drawing a copyright fee for the music source from a user's bank account and the like.

Then, control proceeds to step ST308. The encryption key list 172 registers an encryption key used for decrypting the music source 170 indicated by the identifier acquired from the music distribution server. This encryption key is used to make the music source 170 indicated by the identifier reproducible. This music source is added to the reproducible list 173.

As shown in FIG. 6, for example, the music source acquired from the music distribution server is assigned with identifier C099. In this case, encryption key K099 is embedded in the data area a for the music source 170 corresponding to C099. As a result, this music source 170 becomes reproducible and is added to the reproducible list 173.

Then, at step ST309, the control section waits for completion of adding the music source to the reproducible list 173. When confirming completion of this step, the control section proceeds to step ST310 to reproduce the music source 170 added to the reproducible list 173 by using the decoder 18. This reproduces the music source and terminates the processing without installing the music source 170 indicated by the identifier acquired from the music distribution server.

When it is judged at step ST305 that an identifier of the music source acquired from the music distribution server is registered in the reproducible list 173, control proceeds to step ST306. The decoder 18 is used to reproduce the music source 170 indicated by the identifier stored in the hard disc 17. This reproduces the music source and terminates the processing without installing the music source 170 indicated by the identifier acquired from the music distribution server. At this time, no charging is performed because the copyright fee is already collected.

As mentioned above, when the user acquires an identifier of the music source to be reproduced from the music distribution server, the music source may be already stored in the hard disc 17. In this case, the control section 10 reproduces the music source on condition that the copyright fee is collected.

Accordingly, the user acquires the identifier of the music source 170 stored in the hard disc 17 from the music distribution server. By paying the copyright fee for the music source, the user can immediately reproduce the music source 170 without actually installing it.

At this time, the user purchases the music source via a communication line. Actually, however, no communication line is used for acquiring the music source. The user can acquire the music source within a very short period of time. When the communication line is available for selling music sources, a music source shop can reduce costs because no market channel is needed.

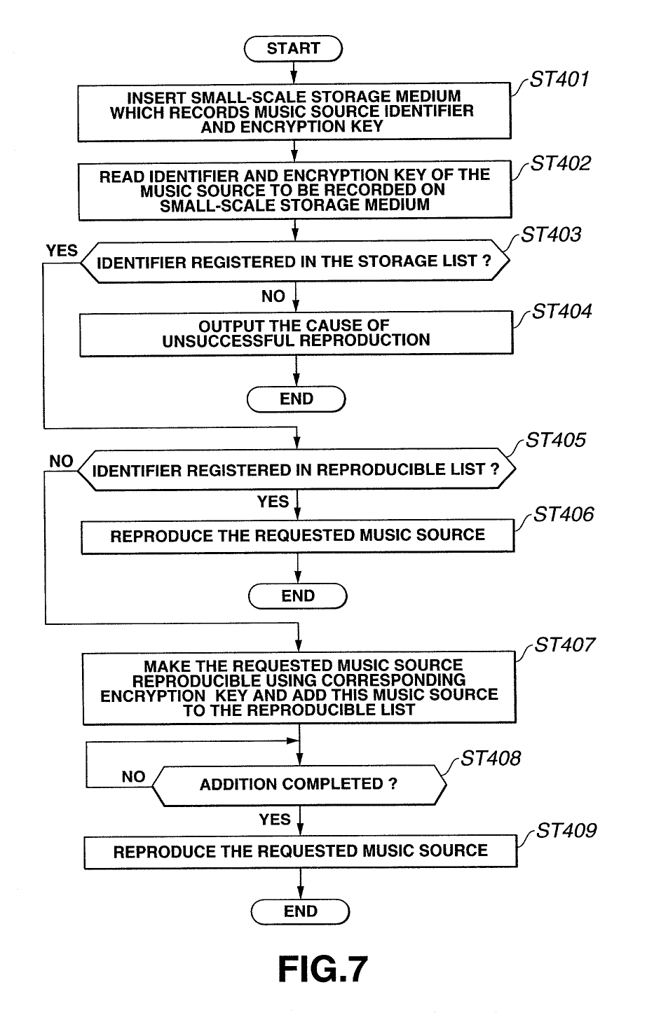

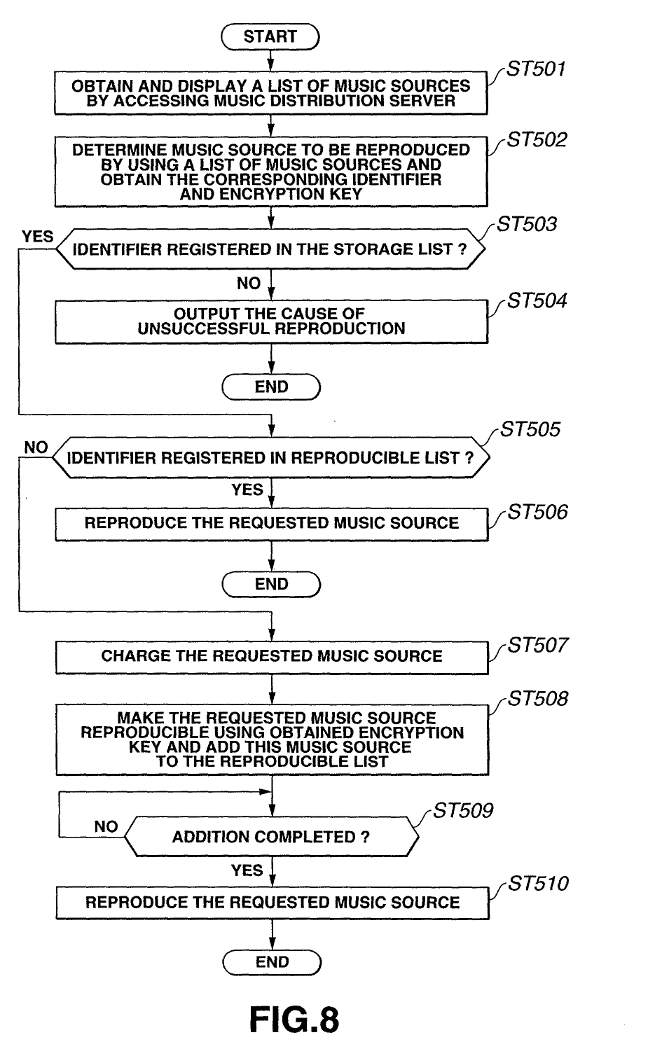

FIGS. 7 and 8 show other embodiments of a processing flow executed by the control section 10. Described below is an embodiment of the present invention according to the processing flow.

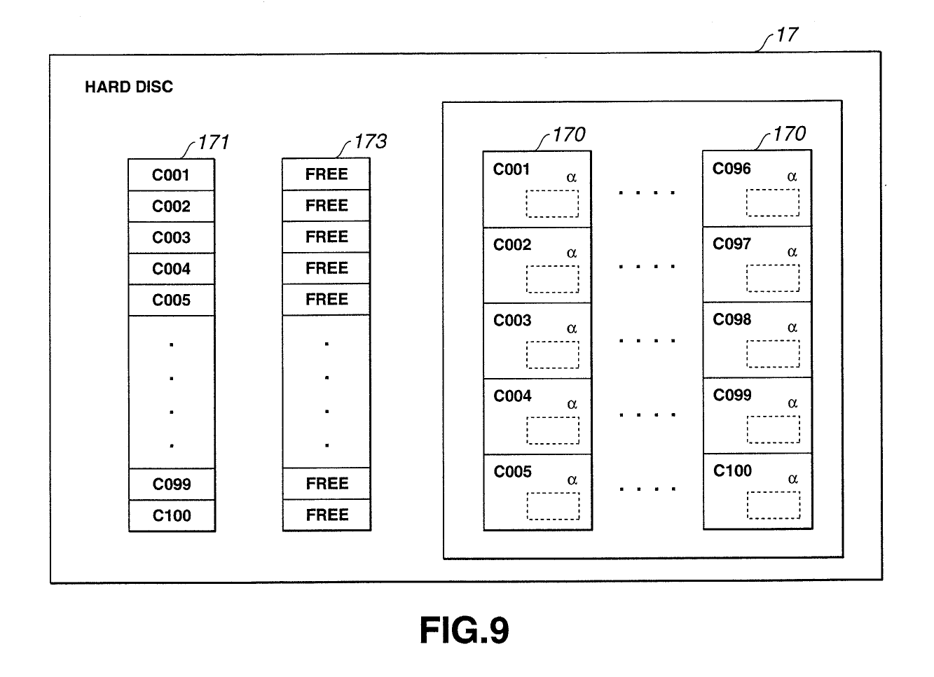

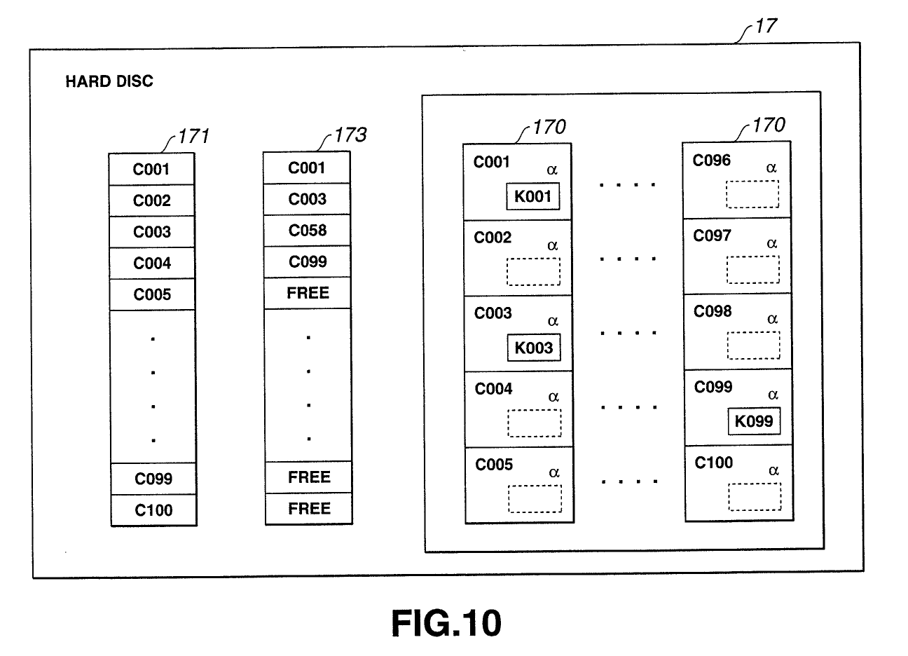

FIG. 9 is shows embodiment of a data structure in a hard disc 17 prepared for implementing an embodiment of the present invention. FIG. 10 explains execution of the control section in FIG. 9. FIGS. 9 and 10 have the same structures as those of FIGS. 5 and 6, respectively. The mutually corresponding parts in these figures are designated by the same reference numerals.

As shown in FIG. 9, the hard disc 17 stores a plurality of encrypted music sources 170. The hard disc contains the storage list 171 and the reproducible list 173. The storage list 171 manages identifiers of the stored music sources 170. The reproducible list 173 manages identifiers of the music sources 170 which are decrypted to be reproducible. This embodiment does not require the encryption key list 172 in FIG. 5.

FIG. 9 shows α which is a data area for the encryption key assigned to the music source 170. When the corresponding encryption key is embedded in this area, the music source 170 becomes reproducible.

Also according to this embodiment, a music source shop sells the hard disc 17 storing a plurality of encrypted music sources 170 without embedding encryption keys in any of these music sources 170. Even if a user purchases the hard disc 17 from the shop, the user cannot reproduce the music source stored therein. Consequently, the music source shop can sell the hard disc 17 inexpensively.

The user may purchase a small-scale storage medium such as a memory card storing a music source identifier from the shop, insert the small-scale storage medium, and issue a request to reproduce the music source. In this case, the control section 10 performs the music source reproduction according to a processing flow in FIG. 7 when the hard disc 17 is mounted.

The user may acquire an identifier and an encryption key of a music source to be requested from a music distribution server and issue a request to reproduce the music source. In this case, the control section 10 performs the music source reproduction according to a processing flow in FIG. 8 when the hard disc 17 is mounted.

First, the following describes the music source reproduction performed by the control section 10 according to the processing flow in FIG. 7.

The user may purchase a small-scale storage medium such as a memory card storing a music source identifier and its encryption key from the shop, insert the small-scale storage medium, and issue a request to reproduce the music source. In this case, the control section 10 first inserts the small-scale storage medium into the medium read apparatus 15 at step ST401 as shown in the processing flow of FIG. 7.

At step ST402, the control section reads an identifier and an encryption key of a music source recorded on the inserted small-scale storage medium. At step ST403, it is judged whether the read identifier is registered in the storage list 171 stored in the hard disc 17. When it is judged that the corresponding identifier is not registered, control proceeds to step ST404. The control section outputs information indicating unsuccessful reproduction and terminates the processing.

When the identifier of the music source read from the small-scale storage medium is judged to be registered in the storage list 171 of the hard disc 17 at step ST403, control proceeds to step ST405. It is judged whether the identifier is registered in the reproducible list 173 of the hard disc 17.

When it is judged that the reproducible list 173 does not register the identifier of the music source read from the small-scale storage medium, control proceeds to step ST407. The encryption key read from the small-scale storage medium is used to make the music source 170 indicated by the identifier reproducible. This music source is added to the reproducible list 173.

As shown in FIG. 10, for example, the music source read from the small-scale storage medium is assigned with identifier C099. In this case, encryption key K099 read from the small-scale storage medium is embedded in the data area α for the music source 170 corresponding to C099. As a result, this music source 170 becomes reproducible and is added to the reproducible list 173.

Then, at step ST408, the control section waits for completion of adding the music source to the reproducible list 173. When confirming completion of this step, the control section proceeds to step ST409 to reproduce the music source 170 added to the reproducible list 173 by using the decoder 18. This reproduces the music source and terminates the processing without installing the music source 170 indicated by the identifier read from the inserted small-scale storage medium.

When it is judged at step ST405 that an identifier of the music source read from the inserted small-scale storage medium is registered in the reproducible list 173, control proceeds to step ST406. The decoder 18 is used to reproduce the music source 170 indicated by the identifier stored in the hard disc 17. This reproduces the music source and terminates the processing without installing the music source 170 indicated by the identifier read from the inserted small-scale storage medium.

As mentioned above, when the user inserts a small-scale storage medium for recording a music source identifier and its encryption key and issues a request to reproduce the music source, the music source may be already stored in the hard disc 17. In this case, the control section 10 reproduces that music source.

Accordingly, the user pays a royalty of the copyright to allow the small-scale storage medium to record an identifier and an encryption key of the music source 170 recorded on the hard disc 17. By inserting the small-scale storage medium into the music reproduction apparatus 1 according to the present invention, the user can immediately reproduce the music source 170 without actually installing it.

Next, the following describes the music source reproduction performed by the control section 10 according to the processing flow in FIG. 8.

The user may acquire an identifier and an encryption key of a music source requested for reproduction from a music distribution server and issue a request to reproduce the music source. In this case, the control section 10 first accesses the music distribution server at step ST501 as shown in the processing flow of FIG. 8. By doing so, the control section acquires a list of music sources to be reproduced and displays it on the display 11.

At step ST502, the displayed list of music sources is used for interaction with the user to judge a music source to be reproduced and acquire the corresponding identifier and encryption key. At step ST503, it is judged whether the acquired identifier is registered in the storage list 171 of the hard disc 17. When it is judged that the identifier is not registered in the list, control proceeds to step ST504. The control section outputs information indicating unsuccessful reproduction and terminates the processing.

When the identifier of the music source acquired from the music distribution server is judged to be registered in the storage list 171 of the hard disc 17 at step ST503, control proceeds to step ST505. It is judged whether that identifier is registered in the reproducible list 173 of the hard disc 17.

When it is judged that the reproducible list 173 does not register the identifier of the music source acquired from the music distribution server, control proceeds to step ST507. The control section charges the music source requested for reproduction by drawing a copyright fee for the music source from a user's bank account and the like.

Then, control proceeds to step ST508. The encryption key acquired from the music distribution server is used to make the music source 170 indicated by the identifier acquired from the music distribution server reproducible. This music source is added to the reproducible list 173.

As shown in FIG. 10, for example, the music source acquired from the music distribution server is assigned with identifier C099. In this case, encryption key K099 acquired from the music distribution server is embedded in the data area α for the music source 170 corresponding to C099. As a result, this music source 170 becomes reproducible and is added to the reproducible list 173.

Then, at step ST509, the control section waits for completion of adding the music source to the reproducible list 173. When confirming completion of this step, the control section proceeds to step ST510 to reproduce the music source 170 added to the reproducible list 173 by using the decoder 18. This reproduces the music source and terminates the processing without installing the music source 170 indicated by the identifier acquired from the music distribution server.

When it is judged at step ST505 that an identifier of the music source acquired from the music distribution server is also registered in the reproducible list 173, control proceeds to step ST506. The decoder 18 is used to reproduce the music source 170 indicated by the identifier stored in the hard disc 17. This reproduces the music source and terminates the processing without installing the music source 170 indicated by the identifier acquired from the music distribution server. At this time, no charging is performed because the copyright fee is already collected.

As mentioned above, when the user acquires an identifier and an encryption key of the music source to be reproduced from the music distribution server, the music source may be already stored in the hard disc 17. In this case, the control section 10 reproduces the music source on condition that the copyright fee is collected.

Accordingly, the user acquires the identifier and the encryption key of the music source 170 stored in the hard disc 17 from the music distribution server. By paying the copyright fee for that music source, the user can immediately reproduce that music source 170 without actually installing it.

At this time, the user purchases the music source via a communication line. Actually, however, no communication line is used for acquiring the music source. The user can acquire the music source within a very short period of time. When the communication line is available for selling music sources, a music source shop can reduce costs because no market channel is needed.

When the embodiment is configured so that the control section reproduces a music source according to the processing flows in FIGS. 7 and 8, an encryption key is input from the outside. Accordingly, as shown in FIG. 9, the hard disc 17 need not have the encryption key list 172 indicated in FIG. 5.

This embodiment has an advantage of reliably preventing the music source 170 stored in the hard disc 17 from illegally being made reproducible.

The above-mentioned music reproduction apparatus 1 of the present invention can provide the following commercial advantages.

A music source shop can collect copyright fees after sales transactions. It is possible to sell the hard disc 17 as a music bank at a low price because no copyright fee needs to be given to the hard disc.

When a user pays for the copyright fee upon purchase of the hard disc 17, the music source shop can sell a reproducible music source stored in the hard disc 17. In this case, the user can easily reproduce many music sources without the need to store a music source in the hard disc 17.

When the user pays for the copyright fee after purchase of the hard disc 17, the user can reproduce the music source 170 stored in the hard disc 17 at any time without the need to store a music source in the hard disc 17.

It is possible to provide the hard disc 17 as a music bank is replaceable. In this case, the music source shop can newly collect charges by erasing the music sources 170 stored in the once sold hard disc 17 and overwriting newly released music works on the same hard disc.

While there have been described specific preferred embodiments of the present invention, it is to be distinctly understood that the present invention is not limited thereto. While the embodiments have explained the present invention by using a music source as an example, the present invention is also applicable to other content data such as a picture source.

What is claimed is:

1. A content reproduction apparatus comprising:
a storage device for storing a plurality of content data encrypted not to be reproduced and an encryption key needed to decrypt said encrypted content data;
means for judging whether said content data is stored in said storage device in an unreproducible form when a medium which is capable of proving that a copyright fee is paid for said content data is inserted; and
means for making said content data judged to be stored in said unreproducible form reproducible by using said encryption key stored in said storage device.

2. A content reproduction apparatus comprising:
a storage device for storing a plurality of content data encrypted not to be reproduced and an encryption key needed to decrypt said encrypted content data;
means for acquiring an identifier of said content data requested to be reproduced via a communication line;
means for executing a charging process needed to acquire said identifier;
means for judging whether said content data indicated by said identifier is stored in said storage device in an unreproducible form; and
means for making said content data judged to be stored in said unreproducible form reproducible by using said encryption key stored in said storage device.

3. A content reproduction apparatus comprising:
a storage device for storing a plurality of content data encrypted not to be reproduced;
means for judging whether said content data is stored in said storage device in an unreproducible form when a medium which stores an encryption key needed to decrypt said content data is inserted; and
means for making said content data judged to be stored in said unreproducible form reproducible by using said encryption key stored in said medium.

4. A content reproduction apparatus comprising:
a storage device for storing a plurality of content data encrypted not to be reproduced;
means for acquiring an encryption key needed to decrypt said content data via a communication line;
means for executing a charging process needed to acquire said encryption key;
means for judging whether said content data corresponding to said encryption key is stored in said storage device in an unreproducible form; and
means for making said content data judged to be stored in said unreproducible from reproducible by using said acquired encryption key.
